(19) United States
(12) Patent Application Publication
(10) Pub. No.: US 2008/0140322 A1
(43) Pub. Date: Jun. 12, 2008

(54) Method and System for Performing and Utilising Load Measurements in the Maintenance of Machine Components and Devices Relating to Papermaking

(75) Inventors: Tatu Pitkänen, Järvenpää (FI); Petteri Lannes, Jokela (FI); Rami Vanninen, Kellokoski (FI); Jussi Koskelainen, Tampere (FI); Matti Kemppainen, Jokela (FI)

Correspondence Address: STIENNON & STIENNON, 612 W. MAIN ST., SUITE 201, P.O. BOX 1667, MADISON, WI, 53701-1667, US

(73) Assignee: METSO PAPER, INC., Helsinki (FI)

(21) Appl. No.: 10/599,941

(22) PCT Filed: Apr. 13, 2005
(86) PCT No.: PCT/FI2005/050117

§ 371 Date: Oct. 13, 2006

(30) Foreign Application Priority Data
Apr. 14, 2004 (FI) 20040533

(51) Int. Cl. G06F 19/00

(52) U.S. Cl. 702/56

(57) ABSTRACT

The invention concerns a method and a system in the maintenance of machine components, devices and systems relating to papermaking, where the condition, state and/or performance of machine components, devices and systems relating to papermaking are monitored by monitoring systems, which are used for performing load measurements and for collecting load measurement data comprising load measurement signals. In the method according to the invention, the measured load measurement data is processed in such a way that of the load measurement data one or more load characteristics are formed, which express the load directed at the machine component or device being measured. In the method according to the invention, load characteristics determined in real time are used as input information for an operational reliability model in order to provide an operational reliability model. The system according to the invention comprises means for processing the measured load measurement data in such a way that of the load measurement data one or more load characteristics are formed, which express the load level directed at the machine part, device, component or system being measured.

### CROSS REFERENCES TO RELATED APPLICATIONS

This application is a U.S. national stage application of International App. No. PCT/FI2005/050117, filed Apr. 13, 2005, the disclosure of which is incorporated by reference herein, and claims priority on Finnish App. No. 20040533, filed Apr. 14, 2004.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention concerns a method and system for performing and utilizing load measurements in the maintenance of machine components, devices and systems relating to papermaking, wherein the condition, state and/or performance of machine components, devices and systems relating to papermaking are monitored by monitoring systems, which are used to carry out load measurements and collect load measurement data comprising load measurement signals. In addition, the invention concerns a method for creating an operational reliability model, in which operational reliability model a criticalness analysis and/or an operational reliability analysis is applied and which is used to produce information for predicting the durability and failure of the machine parts and components of the papermaking machine. The invention also concerns a system in reeling, which system comprises means for measuring quality information of the completed reel, and in connection with the reeler a control system is arranged for determination of reeling parameters.

The invention concerns machines and devices to do with papermaking, which are, among others, machines and devices used in the making and after-treatment of pulp, tissue paper, paper and board. The invention is especially concerned with maintenance of these machines and devices and of electric equipment, hydraulic and pneumatic components and automation systems subjected to vibration and oscillation in association with them and with observation of their operation and with supporting the production. The invention can be applied to the maintenance of the mechanical parts of all machines and devices relating to papermaking, and to those places in particular, where significant mechanical loads occur, such as in reelers and calenders.

The objective for maintenance operations and production support is to achieve a maximum operational reliability and performance at minimum costs. In this context, maintenance means the following sub-areas, among others:

Proactive maintenance, wherein measurement and analyses to do with failure and wear are carried out, which are used as an attempt to prevent in advance any occurrence of failure,

predicting maintenance comprising condition monitoring and condition testing,

preventive maintenance comprising service at regular intervals,

customer support provided by the device supplier, which advises and gives guidance when required,

trouble-shooting done as a remote measure, wherein the device supplier or some other service contract partner does the trouble determination by utilizing remote diagnostic systems,

correcting measures proper, which are taken upon emergence of the failure,

documentation service, which can be, for example, a maintenance service for device documents maintained in a server outside the production plant, and

separate inspections made in order to find out, for example, the wear and tear of welded joints and machine structures.

Doing various maintenance measurements, such as vibration measurements or load measurements, is a part of the maintenance operations for papermaking machines and equivalent. Maintenance measurements are done in order to detect the objects requiring maintenance measures.

According to the state of the art, the machine supplier may do vibration measurements or load measurements as a single performance, or when required, when a trouble situation or a regular inspection calls for a measurement. The results of the measurement are analyzed and a decision on further steps is taken based on the results.

According to the state of the art, the durability, life span and need for service of machine parts and components relating to papermaking are estimated by criticalness analyses and operational reliability models, of which the one in most general use is the RCM (RCM, Reliability Centered Maintenance) model. The results obtained with the operational reliability model are used for estimating, for example, the probability of failure and exchange frequency of components, and based on these estimates the range and number of spare parts are planned. The results given by today's operational reliability models are not very exact and they do not take into account, for example, changes in the load level caused by the manner of operation of machines, such as their running speed.

In the future, the maintenance of a paper or board production plant aims at moving over more and more from the traditional maintenance methods in the direction of proactive and predicting maintenance, whereby predicting maintenance measures based on measurements are used to minimize the occurrence of failure and at the same time the losses caused by interruptions in the production.

### SUMMARY OF THE INVENTION

The present invention aims at presenting a method and system in the maintenance of machine components, devices and systems relating to papermaking, which methods and systems are used for predicting the need for maintenance of mechanical structures.

In addition, the present invention aims at presenting a method and system in the maintenance of machine components, devices and systems relating to papermaking, by which method and system the results of load measurements are analyzed more exactly than before.

An additional objective of the present invention is to present a method and system in the maintenance of machine components, devices and systems relating to papermaking, wherein the load measurement data is utilized more efficiently than before.

An additional objective of the present invention is to present a method and system in the maintenance of machine components, devices and systems relating to papermaking, with the aid of which cumulative information is collected on the stress exerted on mechanical parts based on load measurements.

One more additional objective of the present invention is to present a method and system in the maintenance of machine components, devices and systems relating to papermaking, wherein load measurement information is used in order to make the operational reliability models more exact.

On the one hand, as regards the state of the art especially relating to the reeling of paper or board webs, various types of reelers are known, and the good quality of the web reels reeled with the aid of these has been monitored, for example, by line cameras and by various kinds of optical meters and video meters and, in addition, attempts have been made to control the good quality of reeling with the aid of reeling parameters. In regard to the state of the art, reference can be made to the published application DE 19814407, which presents an arrangement, wherein a knife's operation is optimized based on an instructed neuro-network.

State-of-the-art reelers based on the latest technology, such as, for example, wire reelers, are complicated in their structure and operation, whereby many circumstances affect the quality of the reel being made, and the relationship between the quality of the reel being made and the reeling parameters is not fully known to date. It is in fact an objective of the invention to provide a system to find out the relationship between the reel's good quality and the reeling parameters.

On the other hand, as is known in the state of the art, the condition of papermaking and board-making machines is monitored by various condition monitoring methods as remote diagnostics by utilizing measuring technology, for example, based on risk analyses. In addition, known in the state of the art are various kinds of insurance services, which are based on risk assessment methods and condition-check measurements of insurance companies.

Insurance companies need, among other things, exact information about the condition of the machine/process/plant they have insured. Mere methods of calculation for estimating risks and in this way for estimating any realizing insurance compensations suffice only partly. As machines and processes are becoming increasingly complicated, bigger and more efficient, the risk assessment becomes even more difficult. Risks caused by neglected maintenance and other actions are also enormous. Possible damages to the environment and, of course, personal injuries entail a special risk of huge compensations. Since it is difficult to estimate risks, the insurance companies are obliged to overestimate risks hugely, which leads to big insurance premiums. Besides, the insurance companies must be solvent in order to be able to cope with their payments, should risks come true. More capital than would be necessary is thus tied up in the business operations of insurance companies. Bigger insurance premiums must thus be charged from the customers due to growing risk estimates and capital expenditure. In spite of all, the business is based on estimates that may go wrong. For this reason, although risks are hugely overestimated, the real compensation liability may become higher than estimated in the real situation. The situation is harmful both for the customer and for the insurance company. The costs of both are big. In addition, the customer may omit to insure some parts of his machines in order to cut costs. This, of course, is a bad thing for the insurance company's business, but it may also increase the customer's risks beyond control. Under these circumstances it would be advantageous if the matters relating to risks could be measured, if exact information could be gathered into databases and if reports could be made on it in the desired form. Insurance companies are already doing so in some respects. The insurance companies have measuring teams, which pay visits to insured objects to inspect them (for example, pressurized vessels and other such). However, these are in the nature of random inspections and they are rare. The business of insurance companies, however, is not actually in the line of measuring, testing or analyzing services. Nor are insurance companies likely to have any profound knowledge of the machines they inspect. However, measurements made in situ require much labor and time, which leads to inefficient work and high costs. In fact, big advantages could be achieved with remote monitoring in insurance-related measurements.

It is an additional objective of the invention to bring about a method, where these two factors are combined in such a way that condition monitoring of the papermaking or board-making machine is carried out in such a way that it can be utilized when insuring the product.

The method according to the invention for maintenance of machine components, devices and systems relating to papermaking is mainly characterized in that the measured load measurement data is processed in such a way that of the load measurement data one or more load characteristics are formed, which express the load exerted on the machine component or device being measured.

The method according to the invention for creating an operational reliability model is characterized in that load characteristics determined in real time are used as input information for the operational reliability model.

The system according to the invention is mainly characterized in that the system comprises means for processing the measured load measurement data in such a way that of the load measurement data one or more load characteristics are formed, which express the load level exerted on the machine part, device, component or system being measured.

The system according to the invention in reeling for its part is mainly characterized in that the system comprises means for storage in a data bank of reeling parameter information and results of reel quality measurements, that is, of measurements of the reel's good quality, and of their divergence and for storing the machine's history information based on this information and for finding out correlations between the reeling parameter information and the information on the measurements of the reel's good quality.

In accordance with the invention, constant load measurements are performed on machine components, devices and/or systems of machine units or structural units at the production plant, and the results of these measurements are processed using strength theory methods, statistical methods or other suitable calculation methods, the Rainflow method preferably. By using said calculation method the measurement data is packed into a matrix of a standard size, from which the desired characteristic figures are determined. In this manner it is possible to determine, for example, a characteristic figure expressing the mechanical load directed at each object being measured. By cumulative collection of determined characteristic figures a load history is provided, from which it is possible to predict the future need for maintenance and the useful life of the concerned measured object.

According to the invention, load measurements are performed by a condition monitoring system comprising measurements of machine components and diagnostic units located in connection with structures or separately to monitor in real time the operation of the machine units being measured. A condition monitoring system of this kind is known from Metso Paper Inc.'s FI-20040311 patent application.

An advantage of the present invention is the possibility to determine the life span and useful life of the production plant's devices with significantly better accuracy than with the state-of-the-art methods, which are based on estimates made of earlier maintenance actions. It has not been possible in these estimates to take into account, for example, the effects of updates or of changes in the running method on the loads of devices. The method and system according to the invention provide a significant improvement in the planning and implementation of the maintenance of devices.

The basic idea of the present invention is processing of the complex load measurement data in high quantities into simple characteristics, from which it is possible easily to estimate the load directed at machine components, devices and systems, the load of operation, the wear of operation, the durability and the life span.

According to an advantageous additional embodiment of the invention, the measured and determined load characteristics are connected to chosen process magnitudes, for example, to the machine speed, to the mass of a rotating part, to the nip force, to the efficiency of dewatering, to the temperature, to the pressure or to properties determined from the paper web. From the data determined in this manner it is possible to analyze the effect of each process magnitude on the load directed at each examined machine part, device or component, whereby the accuracy of useful life forecasts can be improved even further.

According to another advantageous additional embodiment of the invention, the load characteristics determined by using the method according to the invention are used as input information for an operational reliability model. It is hereby possible in the operational reliability analysis to take into account the real load directed at machine parts, devices, components and systems, whereby the forecasts given by the operational reliability model concerning maintenance become significantly more accurate.

The present invention provides an overall system, which can be used for a reliable prognosis concerning the useful life and failure rate of any machine part, device, component or system under load measurement.

According to an advantageous application of the invention, a system in reeling is formed, wherein the parameters indicating the good quality of the reel of a reeler/a reeler connected to a slitter are collected in a database. In this advantageous embodiment of the invention, some quality meter is measured in the reel upon completion of the reel. From the reel it is possible to measure, for example, the reel hardness, for example, its average value, and the variation of the reel's hardness profile, that is, the divergence, or a line camera may be used to determine, for example, the shape of the reel end, whereby possible sides or dislocations are found out and in this way determine any variation (divergence) in the shape of the reel end. In addition, by utilizing a line camera or some other equivalent measuring method, for example, a laser, it is possible to determine the reel's shape profile or measure the tension in the reel's surface layer and the tension profile or utilize traditional quality meters, such as the reject quantity. The information given by these quality meters are read into the system and from this into the process database as time-continuous data. Reeling parameters, grade information and other measurement information relating to the reeling environment are also read into the same database of the same system. Based on this information correlation curves are formed between the quality meters, reeling parameters and grade information. The correlation curves for each pair of variables can be presented, for example, in the user interface of the process database, whereby the information provided by them can be utilized in adjustments of the machine. In connection with this embodiment of the invention it is also possible based on the collected information to form a process model, which shows the effect of reeling parameters on each quality meter, and based on the model to search the optimum set of parameters suitable for each grade to be run and allowing achievement of the best quality meter values. The set of parameters is shown, for example, from the user interface, from which the parameters can be downloaded into the system. As information is collected continuously on different situations, which are collected in a memory and are modeled, a databank will be formed, which will be updated all the time. Thus, based on this application of the invention it is possible to collect several different variables and also to compare their combinations. Parameters can also be tested with the desired grade of paper, for example, in a test machine, and this information may be utilized in connection with the manufacture proper. An arrangement of this kind can be connected to a new papermaking or board-making machine to be manufactured or it can be joined afterwards in connection with existing reelers. In addition, this system can be joined to the top level control of other processes preceding the reeler in the papermaking or board-making machine.

The application of the invention described above may be used, for example, in wire nip reeling to find out the effect of wire tension, the wire link's depression, wire tension and peripheral force on the reel's tendency to tilt and it may be implemented, for example, based on clustering and model-based diagnostics observing the quality figures and parameters of reeling. It is possible hereby in the user interfaces to present the relative share of the divergence for each signal in the observed set of signals in online measurements compared with the modeled situation. A known wire nip reeler is presented in the published application WO2004/110909 A1.

In accordance with an advantageous application of the invention, a method is formed, wherein measuring and analyzing services are used in insurance companies, whereby the method based on remote diagnostics allows delivery of the result to the insurance companies, for example, through a web portal. According to this application, such data collection information is used in the measurement, which is known as such or which relates to condition monitoring according to the application of the invention described earlier, and based on this information an estimate is delivered to the insurance company concerning the current condition of the insured object. The measurement information may also be in real time. When based on the condition monitoring information is received about a possible problem, alarms are obtained promptly, whereby it is possible to react preventively to risky situations, whereby the quantity of information available for the insurance company increases, whereby insurance premiums can be determined based on real measurement results. The method is suitable for use, for example, in connection with the control of various machines and devices: pressurized vessels, rotating machines, rolls, process pipe systems, hydraulic equipment, working machines, bearings etc. Monitoring is done, for example, in connection with such devices, which may cause personal injuries, or, for example, such devices, which may cause damages to the environment, or, for example, such devices, where a failure may cause material damages. According to this application of the invention, objects are observed by using remote diagnostics and in this manner the observation by insurance companies is based on information provided by remote diagnostics as are the insurance premiums, which information is preferably provided with the aid of a neutral party, whereby the measuring and analyzing services will work objectively. If the third party is, for example, a device manufacturer, such advantages are achieved as added-value services and utilization of the plant and equipment and various remote diagnostic systems develop and, on the other hand, the insurance companies get exact information to support their decisions and information on possible risky objects. In addition, application of the invention makes it possible for the insurance company to tackle unsatisfactory states of affairs in advance, whereby it can, for example, determine more accurate insurance premiums for those companies, which, for example, do not attend to the condition of their plant and equipment. On the other hand, a customer attending to his plant and equipment may get damages at more advantageous costs. In addition, damages will decrease owing to measurements and analyses, when the problem can be prevented beforehand, which reduces the expenses of all parties and reduces the risk of human injuries and damages to the environment. This application of the invention constitutes a business operation method for determination of the insurance premium level for the production plant or machines/devices, where at least a part of the amount of insurance premiums is determined based on the condition monitoring signal given by diagnostics/remote diagnostics or an equivalent signal. The business operation method according to this application of the invention is suitable for determination of risks in the insurance business, where the risk management utilizes the condition monitoring signal received from the production plant/machines/devices/components by condition monitoring measurement, whereby the business operations can utilize the condition monitoring/remote diagnostics provided by the device manufacturer, to which such a feature is added, which charts how big the insurance risk is, and/or on the other hand, as regards the insurance company it is possible to utilize the condition monitoring measurements even otherwise performed on the insured object in order to determine the insurance risk and thus the insurance premiums.

In the following, the invention will be described in greater detail by referring to the figures shown in the appended drawing, but there is no intention to limit the invention narrowly to the details shown in the figures.

### BRIEF DESCRIPTION OF THE DRAWINGS

FIG. 1 shows an example of a measuring and data collecting system arranged in connection with a papermaking machine for implementation of the method according to the invention.

FIG. 2 illustrates processing of load measurement data and calculation of load characteristics by using the method according to the invention.

FIG. 3A shows a cumulative load accrual curve determined by the method according to the invention.

FIG. 3B shows an instantaneous load level curve determined by the method according to the invention.

FIG. 3C shows a load level change curve determined by the method according to the invention.

FIG. 4 is a schematic view of an application of the invention for a system for finding out the quality indicators of a reel.

FIGS. 5A, 5B, and 5C show some applications for use in process control in connection with the system according to FIG. 4.

### DESCRIPTION OF THE PREFERRED EMBODIMENTS

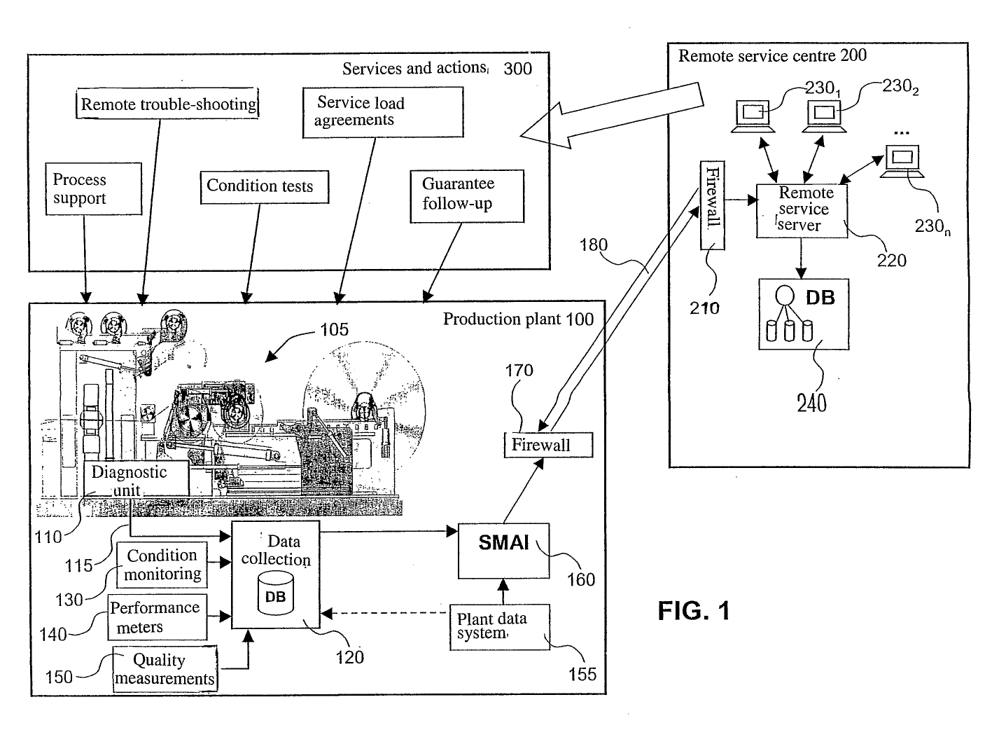

In FIG. 1, an example is shown of a measuring and data collection system, which can be used for implementation of the method according to the invention. In FIG. 1, a papermaking line's 100 unit, which in this example is a reeler unit 105, is equipped with one or more diagnostic units 110, which belong to a condition monitoring system and which are used in the method according to the invention for collecting load measurement data. The diagnostic unit 110 is used to measure the loading of machine parts, devices, components and systems at those places in particular, where significant load levels occur. The diagnostic unit 110 is preferably used, besides for load measurements, also for measuring other magnitudes indicating the mechanical condition, such as driving times, frictions and oscillations. The data collected by diagnostic unit 110 is transferred to a data collecting system, which in this example is a data-collecting unit 120. The data-collecting unit 120 preferably obtains data relating to the condition monitoring also from the production plant's condition monitoring unit 130, from performance meters 140 and from quality measurements 150.

Data-collecting unit 120 comprises a database, wherein data collected from the diagnostic unit 110 and from other condition monitoring systems is stored. Also other data, which can be obtained from the production plant for papermaking and which can be utilized in the method according to the invention, may be supplied to the data-collecting unit 120. The data-collecting unit 120 preferably transmits data to a messaging system, that is an SMAI unit 160 (SMAI, Solution for Messaging and Application Integration), which is a messaging system developed by Metso for processing data relating to failure rates, among other things, and for transferring the data to a remote service center 200 by way of firewalls 170, 210 over a data transmission connection 180.

The data collecting unit 120 described above is a functional entity, which may be a separate unit comprising the required processor capacity for data processing and the required memory capacity as well as database functions for storing data, or its functions can be included in connection with units of another condition monitoring system or in connection with the SMAI unit 160.

The messaging system, that is, SMAI unit 160, is located at the production plant, for example, in connection with other information systems or at some other suitable place, where data communication connections can be arranged both to the diagnostic units 110 and to other condition monitoring systems and also to the remote service center 200. The required data transmission connections may be arranged as wire-line or wireless connections by applying technology known as such. SMAI unit 160 may also be in connection with the production plant's 100 plant data system 155. The plant data system 155 collects, processes and maintains information relating to the follow-up and management of the production plant's 100 production. Alternatively, a connection between SMAI unit 160 and plant data system 155 may also be arranged through data-collecting unit 120 (dashed line in FIG. 1).

The data collected by the method according to the invention can be processed in the production plant's data systems or in the remote service center's 200 data systems 220, 230, 240, if the production plant 100 is connected to a remote service operation. The services and actions 300 provided by the remote service center 200 for the production plant comprise, among other things, process support, remote trouble-shooting, condition tests, service level agreements and guarantee follow-up. To support these functions it is preferable to use the load characteristics determined by the method and system according to the invention.

The invention may also be utilized with the aid of a measurement system of another kind than the one described above. It is then a precondition that load measurement data collected in real time is available.

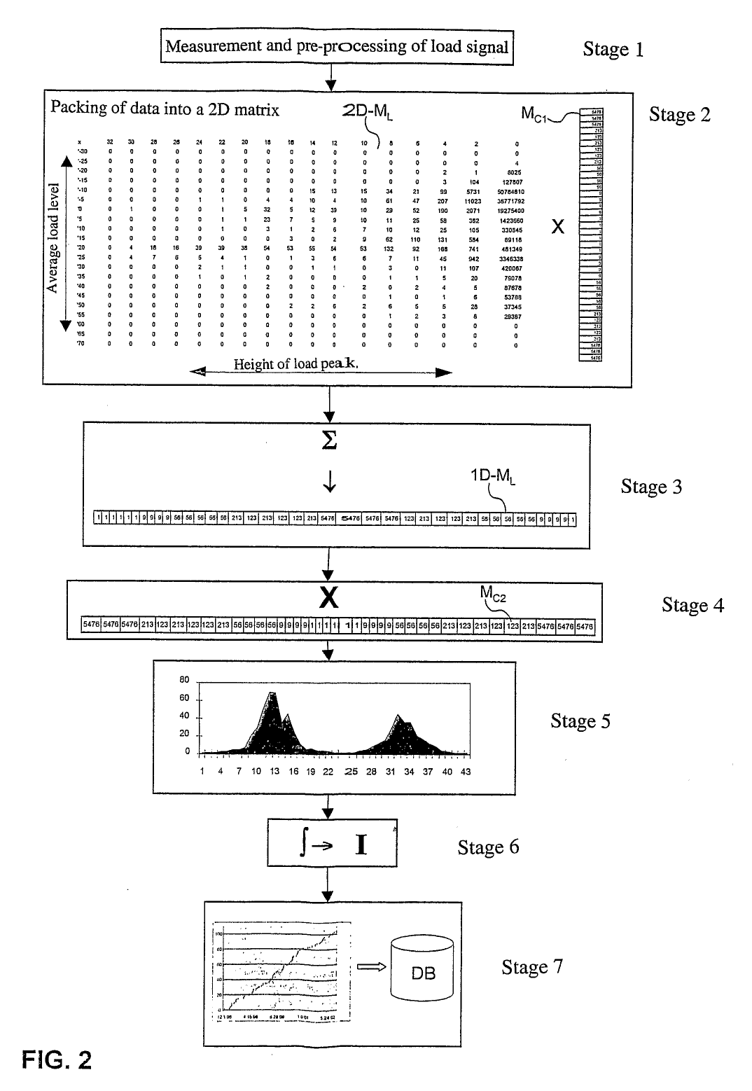

With the aid of an example FIG. 2 illustrates different stages in the processing of load measurement data measured by a measuring and data-collecting system. At stage 1, measurement of the load signal is performed and possibly necessary pre-processing steps are taken with the measurement signal, such as filtration. The load signal comprises, for example, for a one-hour period 3.6 million samples and it is measured, for example, at a sampling frequency of 1000 samples/s. In practice, it is not possible to process such a big quantity of data as such.

At stage 2, the measurement data is packed, for example, by the Rainflow method known as such, or by some other applicable equivalent method into a table, that is, a matrix, of a standard size. In the example shown in FIG. 2, each column in the load measurement data matrix comprises load peaks of a certain height and each line is measured at a different average load level. In this example, the average load level of the measured object is classified on the lines of the load measurement data matrix into classes −30 . . . +70 kN of a uniform size, and the range of variation of load peaks in the columns is 0 . . . 32 kN.

There may be several load measurement data matrixes, if it is desired to examine separately the machine's different states of operation, for example, the different sequence parts with a reeler. In the box showing stage 2 in FIG. 2, an example is shown of a load measurement data matrix 2D-M_{L} and a coefficient vector MC₁ packed into a matrix of the Rainflow type. In order to utilize data packed in such a form it must be converted further into a form more easily processed.

At stage 2, the data of the load measurement data matrix 2D-M_{L} is processed by multiplying the values of the elementary units of the matrix by coefficient vector MC₁, which weights every value of each line. The values of the elementary units of coefficient vector MC₁ are chosen depending on whether the object's fatigue, wear or yield durability is to be measured. Multiplying by the coefficient vector MC₁ will weight, for example, higher load peaks more than low peaks and takes into account the effect of average load when close to the yield limit of the measured object. As a consequence of multiplication by coefficient vector MC₁, that information of the data of load measurement data matrix 2D-M_{L}, which is correct in terms of strength theory, is preserved. The values of the coefficient vector can be calculated using a suitable formula, for example, by using a windowing function.

At stage 3, the values of each column in the load measurement data matrix are added together, whereby the load peaks measured at each average load are summed. Thus, a 1-dimensional load measurement data matrix 1D-M_{L} is formed, of which an example is shown in FIG. 2 in the box presenting stage 3.

At stage 4, the 1-dimensional load measurement data matrix 1D-M_{L} is multiplied by coefficient vector MC_{C2}, the values of the latter's elementary units being chosen depending on whether the object's fatigue, wear or yield durability is to be measured. The result obtained is a 1-dimensional vector, and the values of the vector's elementary units are shown as a descriptor in the box presenting stage 5. In the descriptor, the horizontal axis indicates the height of the load peak weighted according to the average load, whereas the vertical axis indicates the number of load peaks of each height, that is, the cumulative accrual of load peaks of each height.

At stage 6, an addition is done of the elementary units of the vector calculated at stage 4, which corresponds with the integration of the surface area of the curve shown at stage 5. This results in one characteristic, that is, a characteristic I indicating the cumulative load accrual and representing the load rate or wear rate directed at the measured object by the measured force.

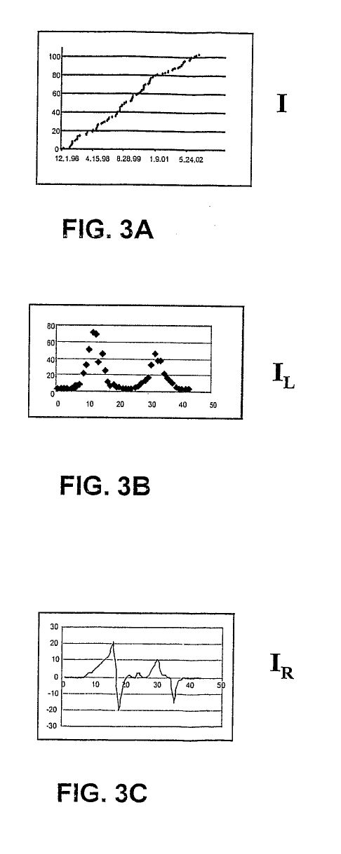

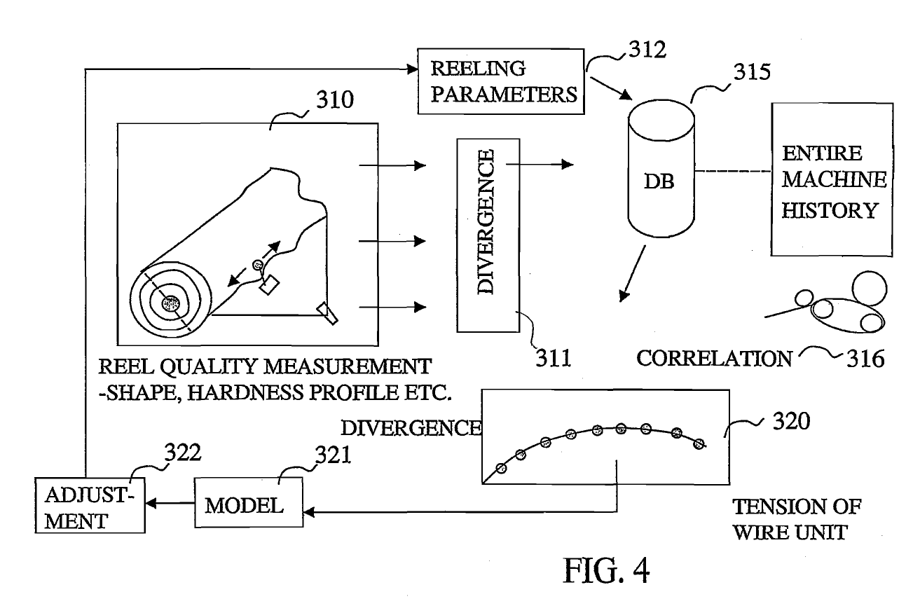

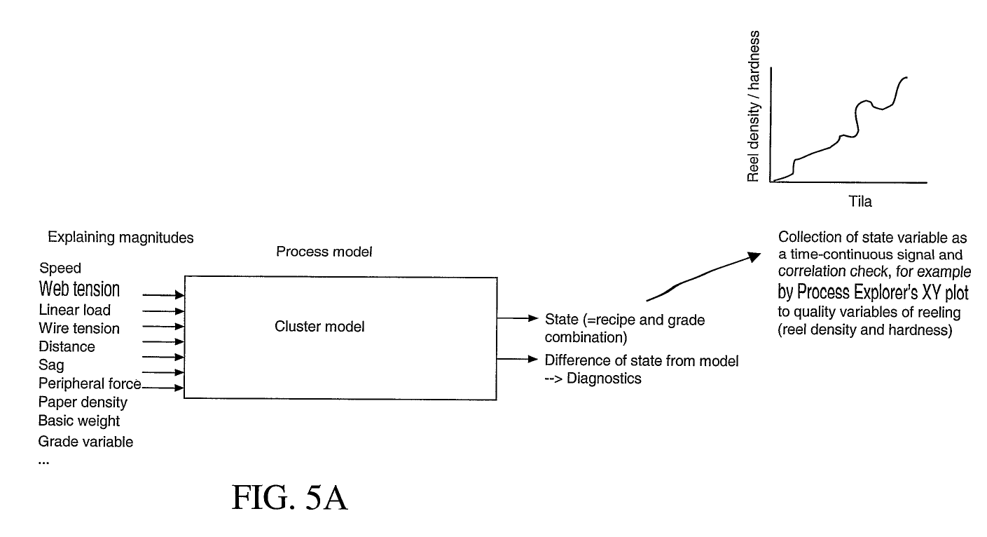

The actions of stages 1-6 described above are preferably repeated at regular intervals, for example, once a minute, an hour or per operational sequence of the machine, whereby a new value is determined for the cumulative load accrual characteristic I. In this manner, the cumulative load accrual characteristics I determined at different moments are collected in a process database DB at stage 7 shown in FIG. 2. The collected information can be presented, for example, as a load history curve, like the one shown in a box at stage 7, wherein the cumulative load accrual characteristic I is shown as a function of time. Said descriptor is described in greater detail in connection with the description of FIG. 3A.

Besides the stages presented in FIG. 2, the matrixes to be processed are adapted to have mutually suitable sizes, when required, so that they can be used for implementation of the necessary mathematical operations. The adaptation is done by methods known as such, for example, by interpolation.

The following is a description in greater detail of characteristics determined by the method according to the invention, whose descriptors are presented in FIGS. 3A, 3B and 3C.

FIG. 3A shows a cumulative load accrual characteristic I determined by the method according to the invention as a function of time. The cumulative load accrual characteristic I tells how great a totaled load has been directed at the measured object during the time when load measurement data has been collected on the measured object.

By determination of a difference quotient between two sample points on the cumulative load accrual characteristic's history curve, which with a constant sample interval corresponds with the difference, the instantaneous load level is found out. FIG. 3B shows the descriptor of the load level value I_{L} indicating this instantaneous load level as a function of time. The load level value I_{L} expresses what level of loading is directed at the measured object at each moment, and alarm limits may be established for it. In this manner an alarm is brought about, when an instantaneous load indicating a trouble situation rises to be higher than the alarm limit value.

By further determination of another derivative from the curve indicating a load level value as shown in FIG. 3B, the rate and direction of change in the load level are found out. FIG. 3C shows a curve indicating the rate of change in the load level thus determined as a function of time. It can be seen in the load level change curve I_{R} in which direction the load is developing and at which rate the development is proceeding. In a normal situation, the change curve of the load level should be even and the change values of the load level should be close to zero. Alarm limits may also be established for the load level change value I_{R}, and according to these limits an alarm will be set off to the operator, the maintenance operation and/or the remote service center, when the alarm limits are exceeded.

The system according to the invention for processing load measurement signals comprises means for processing the measured load measurement data in such a way that one or more load characteristics are formed of the load measurement data, which express the load level directed at the machine part, device, component or system forming the measured object. The processing is provided by a computer program suitable for the purpose.

According to an advantageous additional embodiment of the invention, the measured/determined load characteristics are connected to chosen process magnitudes, for example, to the machine speed, to the mass of a rotating part or to the nip force, or to other measurements, such as pressure measurements, temperature measurements, oscillation measurements or to quality measurements of the paper web. From the data thus determined it is possible to analyze the effect of each process magnitude on the load of the examined object, whereby it is possible to improve even further the accuracy of useful life forecasts. For example, when running with great nip loads, it is possible to determine the future need for exchange of machine parts or components.

According to another advantageous embodiment of the invention, the load characteristics determined by the method according to the invention are used as input information to an operational reliability model for the machine part, device, components or system forming the measured object or to a system estimating the operational reliability, such as an RCM (RCM, Reliability Centered Maintenance) system, or in other corresponding systems used for determination of the operational reliability of devices relating to papermaking. Criticalness analysis and operational reliability analysis is applied in the operational reliability model. The operational reliability determination is used to predict the failure interval of machine parts, devices and components and the resulting optimum exchange frequency, and with its aid it is possible, for example, to determine the necessary stock of spare parts. It is especially important to determine the need for spare parts of critical components, whose failure can interrupt the entire production.

By updating, preferably constantly, the criticalness analysis program, the operational reliability model or the operational reliability system by load characteristics determined by on-line measurements a significantly more reliable forecast than before is obtained of the life span of machine parts, devices and components. Different loads and different ways of running machine parts, devices and components of a corresponding kind cause wearing and ageing of their machine parts or components at different rates. The load characteristics determined according to the present method are taken into account in the operational reliability model, whereby the life span forecast for the examined machine part, device or component will be correspondingly updated. In this manner significant savings are achieved, when earlier wear of the machine part, device, system or component can be better predicted when the operating conditions are tougher than usual and the wear can be taken into account in the predicting maintenance. Correspondingly, savings are achieved when the running conditions have been less loading than usual and the time for servicing/exchanging the machine parts can be postponed.

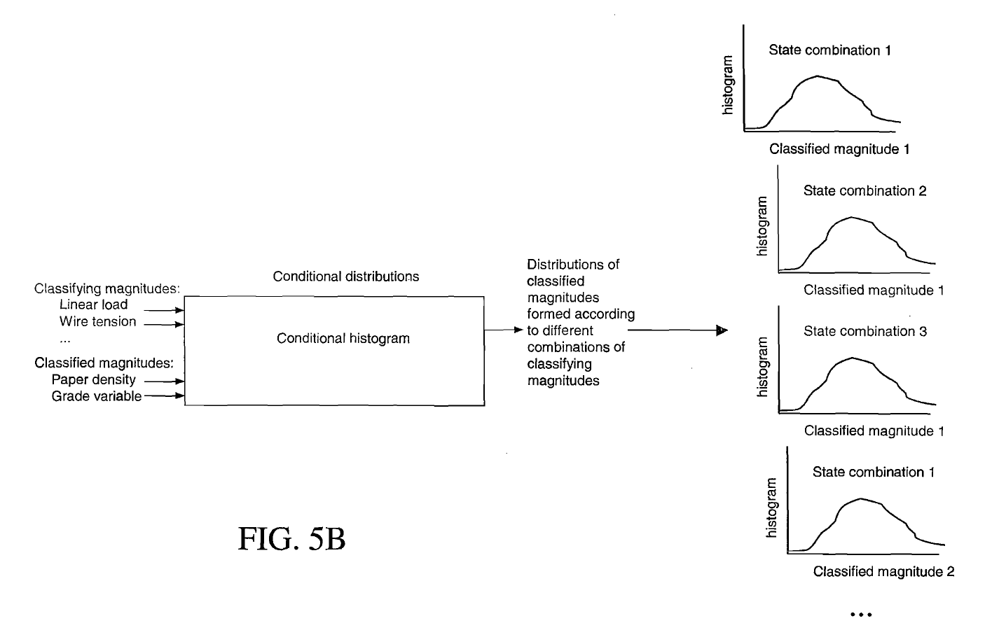

According to FIG. 4, the quality measurement results 310 of a reel, such as measurement results concerning the shape, hardness profile etc., as well as information on the divergence 311 of these quality measurement results are transferred to a database 315, to which database 315 information is also supplied on the reeling parameters 312 used, whereby it is possible to find out the correlation 316 between the reeling parameters 312 and the reel's quality measurements 310. The information 310, 312 is collected in a database 315 concerned with the entire history of the machine. Added to the reeling parameter information 312 is information relating to various measurements 320, for example, relating to the web tension 322 and to the divergence of measurement results, which are modeled 321 and adjusted according to the reeling process.

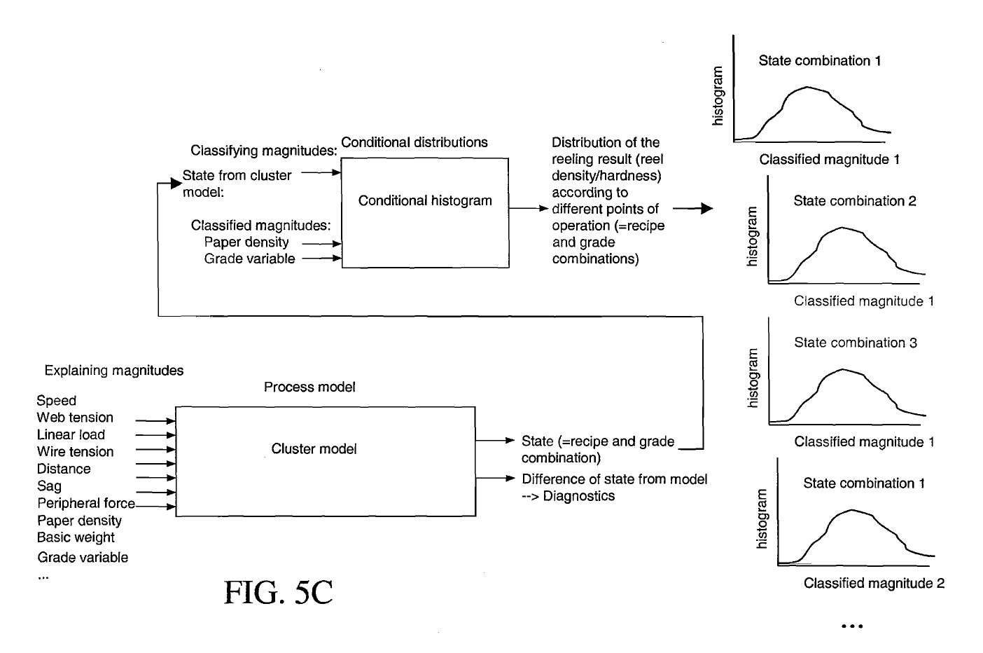

In the application shown in FIG. 5A of the system shown in FIG. 4, grade-specific information is obtained on the effect of various reeling recipes on the reel's hardness or other equivalent characteristic. With the reeling recipe the reeling parameters are determined in such a way that the quality of the reel being formed is good. The model is based on explaining magnitudes, such as speed, web tension, linear load, wire tension, distance, sag, peripheral force, paper density in the basis weight and other such grade variables, which based on the process model, for example, a cluster model, are processed in such a way that information is obtained on the state of the reeling recipe and paper grade combination and on the difference from that state from the model based on the diagnostics, whereby the state variable information is collected as a time-continuous signal and a correlation check is carried out on the quality variables of reeling, that is, for example, the reel density and hardness.

FIG. 5B shows an application of the method according to FIG. 4, where information is obtained on the effect of different parameters on the reel hardness or equivalent, where the classifying magnitudes, for example, the linear load and the wire tension, and, on the other hand, the magnitudes to be classified, such as the paper density and other grade variables concerning it, are supplied as conditional distribution information into a conditional histogram, whereby distributions of classified magnitudes formed according to different combinations of the classifying magnitudes are brought about, based on which it is possible to form histograms concerning different state combinations as a function of the classified magnitude.

In connection with FIG. 5C an application is shown, wherein a different recipe is obtained and the effect of grade combinations, for example, on the reel hardness. The applications according to FIGS. 5A and 5B are combined here, whereby a histogram is obtained, which is formed according to the result of reeling, that is, through the reel density the distribution of hardness according to different points of operation, that is, different reeling recipes and grade combinations and different state combinations according to the classified magnitude.

In the foregoing, the invention has been described by referring to some of its advantageous embodiments only, but there is no intention to limit the invention narrowly to their details. Many modifications and variations are possible within the scope of the inventive idea defined in the following claims.

1-21. (canceled)

22. A method of maintenance of machine components in a papermaking machine, reeler, or calender, the method comprising:
measuring vibrational load characteristics comprising a multiplicity of load oscillations over a selected period of time of at least one machine component to produce load measurement data;
processing the load measurement data using a calculation method wherein the load measurement data is packed into a matrix of a selected size;
processing the load measurement data, to form a load history; and
using the load history to predict the future need for maintenance or the useful life of the machine component.

23. The method of claim 22 wherein the load history includes a cumulative load accrual (I), a plurality of successive instantaneous load level values (I_{L}), and a plurality of successive instantaneous load level change values (I_{R}).

24. The method of claim 22 wherein the step of processing the load measurement data using the calculation method comprises packing the data into a matrix of two dimensions, the dimensions being peak load values and average load values, so that each element of the matrix has a range of peak load values, and a range of average load values, and further comprising the steps of:
forming the matrix by determining for each measured load oscillation an average load and a peak load, and packing the measured data into the matrix of a selected size by incrementing a corresponding element in the matrix;
selecting a first coefficient vector for weighting the load measurement data;
multiplying each element of the matrix having the same average load by an element of the first coefficient vector;
summing matrix elements of the same peak load to form a one-dimensional load measurement data matrix;
selecting a second coefficient vector for weighting the load measurement data of the one-dimensional load measurement data matrix;
multiplying each element of the one-dimensional load measurement data matrix by an element of the second coefficient vector to form a weighted one-dimensional load measurement data matrix of weighted elements; and
summing the weighted elements to form a cumulative load accrual characteristic for the at least one machine component.

25. The method of claim 22 wherein the load measurement signals are packed into a load measurement data matrix by using the Rainflow method.

26. The method of claim 24 wherein the values of the first and second coefficient vector are selected to determine one of fatigue, wear or yield durability of the at least one machine component.

27. The method of claim 22 wherein processing of the load measurement data is performed in real time by an online measuring arrangement.

28. The method of claim 24, wherein the step of measuring vibrational load characteristics over a selected period of time is performed for a plurality of successive selected periods of time and further comprising the steps of:
calculating successive load accrual characteristics, and
further calculating a difference between successive load accrual characteristics to determine a plurality of successive instantaneous load level values for the at least one machine component.

29. The method of claim 28, wherein from the successive instantaneous load level values a difference is calculated in order to determine an instantaneous load level change value for the at least one machine component.

30. The method of claim 28, wherein the plurality of successive selected periods of time are regular intervals of time.

31. The method of claim 22, wherein the load history including cumulative load accrual characteristics are stored in a database and used for long-term monitoring of the load characteristic values.

32. The method of claim 22, wherein the step of measuring vibrational load characteristics over a selected period of time is performed for a plurality of successive selected periods of time and for each successive selected period of time processing the measured data using the calculation method wherein the load measurement data is packed into the matrix of a selected size, and each matrix is processed to form a part of the load history, and further comprising for each selected period of time storing a correlated measurement of paper machine speed in the papermaking machine, reeler, or calender.

33. The method of claim 22, wherein the step of measuring vibrational load characteristics over a selected period of time is performed for a plurality of successive selected periods of time and for each successive selected period of time processing the measuring data using the calculation method wherein the load measurement data is packed into the matrix of a selected size, and each matrix is processed to form a part of the load history, and wherein the at least one machine component forms a nip, and further comprising for each selected period of time storing a correlated measurement of nip force of the formed nip.

34. The method of claim 22 wherein the step of measuring vibrational load characteristics over a selected period of time is performed for a plurality of successive selected periods of time and for each successive selected period of time processing the load measurement data using the calculation method wherein the load measurement data is packed into the matrix of a selected size, and each matrix is processed to form a part of the load history, and wherein a paper web is passed through the at least one machine component; and further comprising for each selected period of time storing a correlated measurement of the quality of the paper web.

35. The method of claim 22 wherein the step of measuring vibrational load characteristics over a selected period of time is performed for a plurality of successive selected periods of time and for each successive selected period of time processing the load measurement data using the calculation method wherein the load measurement data is packed into the matrix of a selected size, and each matrix is processed to form a part of the load history, and wherein a paper web is passed through the at least one machine component, and wherein the at least one machine component has a mass which is increasing with time; and further comprising for each selected period of time storing a correlated measurement of the at least one machine component mass.

36. The method of claim 22, wherein the step of measuring vibrational load characteristics over a selected period of time is performed for a plurality of successive selected periods of time and for each successive selected period of time processing the load measurement data using the calculation method wherein the load measurement data is packed into the matrix of a selected size, and each matrix is processed to form a part of the load history, and wherein the at least one machine component has variable temperature which varies with time; and further comprising for each selected period of time storing a correlated measurement of temperature.

37. The method of claim 22, wherein the step of measuring vibrational load characteristics over a selected period of time is performed for a plurality of successive selected periods of time and for each successive selected period of time processing the load measurement data using the calculation method wherein the load measurement data is packed into the matrix of a selected size, and each matrix is processed to form a part of the load history, and wherein the at least one machine component has a pressure which varies with time; and further comprising for each selected period of time storing a correlated measurement of pressure.

38. The method of claim 22, further comprising the steps of:
setting a permissible range for values of the load history; and
bringing about an alarm signal when the values of the load history are outside the set permissible range.

39. The method of claim 22 further comprising the step of modeling operational reliability of the at least one machine component with load characteristics from the load history.

40. The method of claim 29 further comprising operating the papermaking machine, reeler, or calender so as to minimize the instantaneous load level change value.

41. The method of claim 22, wherein the steps of measuring vibrational load characteristics comprising a multiplicity of load oscillations over a selected period of time; processing the load measurement data to form a load history; and predicting future need for maintenance or the useful life, are performed with respect to a multiplicity of machine components, such that preventive maintenance and spares inventories for the papermaking machine, reeler, or calender, are optimized based thereon.

42. The method of claim 23 further comprising predicting reliability of the papermaking machine, reeler, or calender based on the cumulative load accrual (I), the plurality of successive instantaneous load level values (I_{L}), and the plurality of successive instantaneous load level change values (I_{R}).

43. The method of claim 23 further comprising determining spare parts exchange intervals of the papermaking machine, reeler, or calender based on the cumulative load accrual (I), the plurality of successive instantaneous load level values (I_{L}), and the plurality of successive instantaneous load level change values (I_{R}).

44. The method of claim 23 further comprising selecting a composition of spare parts stock of the papermaking machine, reeler, or calender based on the cumulative load accrual (I), the plurality of successive instantaneous load level values (I_{L}), and the plurality of successive instantaneous load level change values (I_{R}).
